(19) United States
(12) Patent Application Publication
(10) Pub. No.: US 2023/0362624 A1
(43) Pub. Date: Nov. 9, 2023

(54) USER EQUIPMENT AGGREGATION

(71) Applicant: Apple Inc., Cupertino, CA (US)

(72) Inventors: Sudeep Manithara Vamanan, Nuremberg (DE); Alexander Sirotkin, Hod Hasharon (IL); Haijing Hu, Los Gatos, CA (US); Krisztian Kiss, Hayward, CA (US); Mona Agnel, Uxbridge (GB); Pavan Nuggehalli, San Carlos, CA (US); Vivek G. Gupta, San Jose, CA (US)

(73) Assignee: Apple Inc., Cupertino, CA (US)

(21) Appl. No.: 18/132,316

(22) Filed: Apr. 7, 2023

Related U.S. Application Data
(60) Provisional application No. 63/338,346, filed on May 4, 2022.

(51) Int. Cl. H04W 8/22; H04W 76/10; H04W 60/04

(52) U.S. Cl. CPC H04W 8/22; H04W 76/10; H04W 60/04

(57) ABSTRACT

The present application relates to user equipment (UE) aggregation. For instance, a UE aggregation group is defined based on a subscription of multiple UEs with a network. Configuration information identifying the UE aggregation group, its member UEs, the role of each UE (e.g., whether a group leader or, otherwise, a group member), and/or radio access capability signaling (RACS) is stored. Upon a registration of a UE, the UE aggregation group is indicated to the network. The network then enables an aggregated communication capability to the UEs of the UE aggregation group based on the configuration information.

### CROSS-REFERENCE TO RELATED APPLICATION

This application claims the benefit of U.S. Provisional Patent Application No. 63/338,346, filed on May 4, 2022, which is herein incorporated by reference in its entirety for all purposes.

### BACKGROUND

Cellular communications can be defined in various standards to enable communications between a user equipment and a cellular network. For example, Fifth generation mobile network (5G) is a wireless standard that aims to improve upon data transmission speed, reliability, availability, and more.

### BRIEF DESCRIPTION OF THE DRAWINGS

FIG. 1 illustrates an example of a 5G network architecture that incorporates both 3GPP (e.g., cellular) and non-3GPP (e.g., non-cellular) access to the 5G core network, in accordance with some embodiments.

FIG. 2 illustrates an example of a 5G network architecture that incorporates both dual 3GPP (e.g., LTE and 5G NR) access and non-3GPP access to the 5G core network, in accordance with some embodiments.

FIG. 3 illustrates an example of a baseband processor architecture for a UE, in accordance with some embodiments.

FIG. 4 illustrates an example of a user equipment (UE) aggregation, in accordance with some embodiments.

FIG. 5 illustrates an example of configuration information for a UE aggregation, in accordance with some embodiments.

FIG. 6 illustrates an example of a quality of service (QoS) flow aggregation, in accordance with some embodiments.

FIG. 7 illustrates an example of an operational flow/algorithmic structure for a QoS flow aggregation, in accordance with some embodiments.

FIG. 8 illustrates an example of a sequence diagram for a QoS flow aggregation, in accordance with some embodiments.

FIG. 9 illustrates an example of a radio access network (RAN) level aggregation, in accordance with some embodiments.

FIG. 10 illustrates an example of an operational flow/algorithmic structure for a RAN level aggregation, in accordance with some embodiments.

FIG. 11 illustrates an example of a sequence diagram for a RAN level aggregation, in accordance with some embodiments.

FIG. 12 illustrates an example of an operational flow/algorithmic structure for a network to participate in a UE aggregation, in accordance with some embodiments.

FIG. 13 illustrates an example of an operational flow/algorithmic structure for a UE to participate in UE aggregation, in accordance with some embodiments.

FIG. 14 illustrates an example of receive components, in accordance with some embodiments.

FIG. 15 illustrates an example of a UE, in accordance with some embodiments.

FIG. 16 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Generally, a group of devices (referred to herein as a device group) can be formed to provide an aggregated communication capability. Absent the aggregation, each device can function independently of the other devices to communicate with the network. When the aggregation is enabled, the devices can function dependently on each other such that each of the devices can provide a particular set of communication capabilities. The collective set of such capabilities correspond to the aggregated communication capability (e.g., the aggregated communication capability includes the collection of communication capabilities of the devices that belong to the device group). When the aggregation is enabled, each device may nonetheless retain its independent communication function when, for instance, this communication function does not involve a communication capability included in the aggregated communication capability.

In an example, prior to the aggregation being enabled, configuration information can be stored by the network to identify the device group and the devices thereof. The configuration information can also identify the role of each device in the group and its particular communication capability set. For instance, the device group can include a leader device (also referred to herein as a convener device or a main device) and a number of member devices (also referred to herein as follower devices or secondary devices). Such roles are indicated as attributes in the configuration information. Similar configuration information may be stored by each device too.

To enable the aggregation, the leader device can identify the device group to the network and, optionally, some or all of the member devices to participate in the aggregation. Each one of such member devices can also identify the device group to the network and, optionally, its particular set of communication capabilities. In turn, the network enables the aggregated communication capability across the leader device and the relevant member devices. While the aggregation is enabled and for the purpose of the aggregation, a non-access stratum (NAS) of the leader device can be active, whereas a NAS of each of the member devices may not be active.

Embodiments of the present disclosure are described in connection with 5G networks. However, the embodiments are not limited as such and similarly apply to other types of communication networks including cellular networks. Further, the embodiments are described in connection with example user equipment (UEs), such as smartphones, laptops, smart glasses, smart headphones, smart watches, and the like. However, the embodiments are not limited as such and equivalently apply to any type of devices capable of radio communications and configured, per the embodiments herein, to support a device group in support of an aggregated communication capability.

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

The term “Non-3GPP Access” refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC), whereas untrusted non-3GPP accesses interwork with the EPC/5GC via a network entity, such as an Evolved Packet Data Gateway and/or a 5G NR gateway. In general, non-3GPP access refers to various types of non-cellular access technologies.

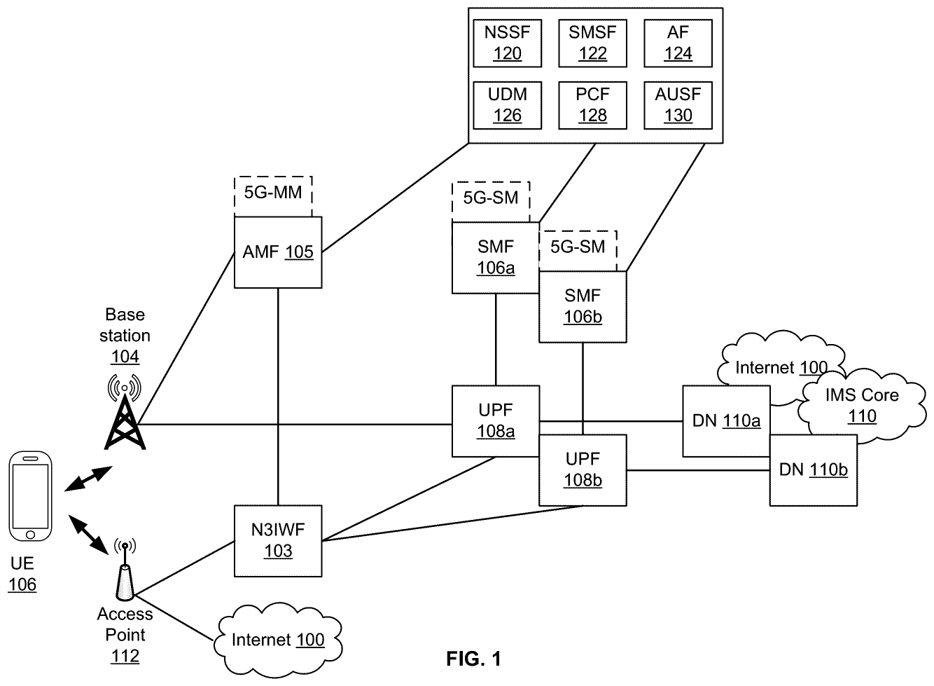

FIG. 1 illustrates an example of a 5G network architecture that incorporates both 3GPP (e.g., cellular) and non-3GPP (e.g., non-cellular) access to a 5G Core network (CN), in accordance with some embodiments. As shown, a UE 106 may access the 5G CN through both a radio access network (RAN, e.g., a base station 104 that can be a gNB) and an access point (AP) 112. The AP 112 may include a connection to the Internet 100 as well as a connection to a non-3GPP inter-working function (N3IWF) 103 network entity. The N3IWF may include a connection to a core access and mobility management function (AMF) 105 of the 5G CN. The AMF 105 may include an instance of a 5G mobility management (5G MM) function associated with the UE 106. In addition, the RAN (e.g., the base station 104) may also have a connection to the AMF 105. Thus, the 5G CN may support unified authentication over both connections as well as allow simultaneous registration for UE 106 access via both gNB 104 and AP 112. As shown, the AMF 105 may include one or more functional entities associated with the 5G CN (e.g., network slice selection function (NSSF) 120, short message service function (SMSF) 122, application function (AF) 124, unified data management (UDM) 126, policy control function (PCF) 128, and/or authentication server function (AUSF) 130). Note that these functional entities may also be supported by a session management function (SMF) 106a and an SMF 106b of the 5G CN. The AMF 105 may be connected to (or in communication with) the SMF 106a. Further, the base station 104 may be in communication with (or connected to) a user plane function (UPF) 108a that may also be in communication with the SMF 106a. Similarly, the N3IWF 103 may be communicating with a UPF 108b that may also be communicating with the SMF 106b. Both UPFs may be communicating with the data network (e.g., DN 110a and 110b) and/or the Internet 100 and Internet Protocol (IP) Multimedia Subsystem/IP Multimedia Core Network Subsystem (IMS) core network 110.

Generally, base station 104 communicates over a transmission medium with one or more UEs (e.g., including the UE 106). Each of the user devices may be referred to herein as a “user equipment” (UE). The base station (BS) 104 may be a base transceiver station (BTS) or cell site (a “cellular base station”) and may include hardware that enables wireless communication with the UE 106.

The communication area (or coverage area) of the base station 104 may be referred to as a “cell.” The base station 104 and the UE 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), and/or HSPA, 3GPP2 CDMA2000 (e.g., 1×RTT, 1×EV-DO, HRPD, eHRPD). If the base station 104 is implemented in the context of LTE, it may alternately be referred to as an ‘eNodeB’ or ‘eNB’. If base station 104 is implemented in the context of 5G NR, it may alternately be referred to as ‘gNodeB’ or ‘gNB’.

The base station 104 may also be equipped to communicate with a network (e.g., a core network of a cellular service provider, such as the 5G CN, a telecommunication network, such as a public switched telephone network (PSTN), and/or the Internet, among various possibilities). Thus, the base station 104 may facilitate communication between the user devices and/or between the UE 106 and the network. In particular, the cellular base station 104 may provide UEs 106 with various telecommunication capabilities, such as voice, SMS, and/or data services.

The base station 104 and other similar base stations operating according to the same or a different cellular communication standard may thus be provided as a network of cells, which may provide continuous or nearly continuous overlapping service to UE 106 and similar devices over a geographic area via one or more cellular communication standards.

Thus, while base station 104 may act as a “serving cell” for UE 106 as illustrated in FIG. 1, the UE 106 may also be capable of receiving signals from (and possibly within communication range of) one or more other cells, which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size.

In some embodiments, the base station 104 may be a next generation base station, e.g., a 5G New Radio (5G NR) base station, or “gNB”. In some embodiments, a gNB may also be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

The UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD)). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

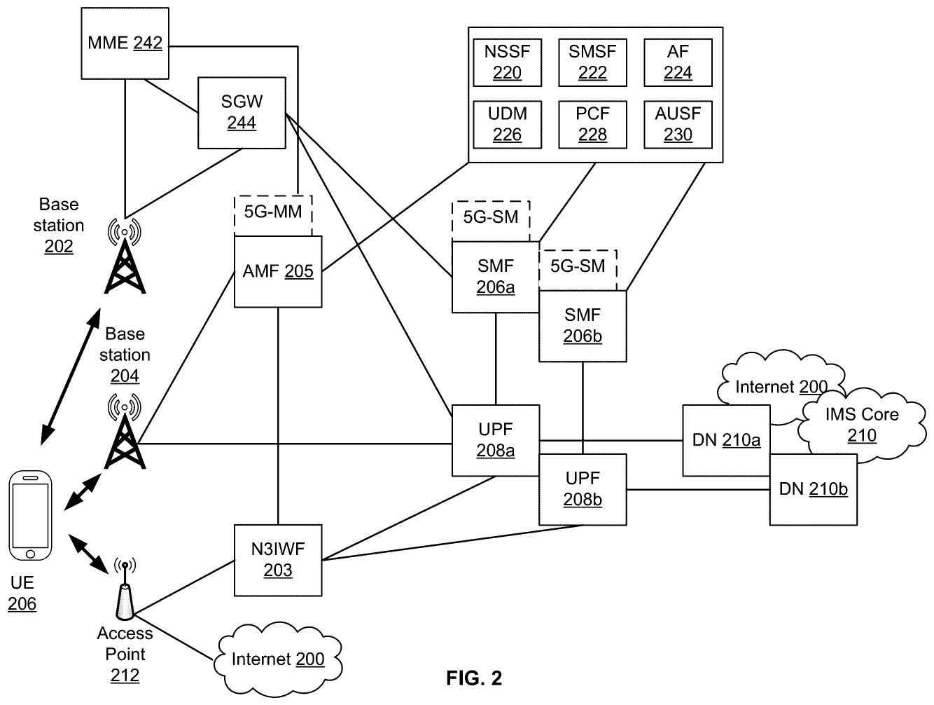

FIG. 2 illustrates an example of a 5G network architecture that incorporates both dual 3GPP (e.g., LTE and 5G NR) access and non-3GPP access to the 5G CN, in accordance with some embodiments. As shown, a UE 206 may access the 5G CN through both a RAN (e.g., a base station 204, such as gNB) and an AP 212. The AP 212 may include a connection to the Internet 200 as well as a connection to a N3IWF 203 network entity. The N3IWF 203 may include a connection to an AMF 205 of the 5G CN. The AMF 205 may include an instance of a 5G MM function associated with the UE 206. In addition, the RAN (e.g., the base station 204) may also have a connection to the AMF 205. Thus, the 5G CN may support unified authentication over both connections as well as allow simultaneous registration for UE 206 access via both the base station 204 and the AP 212. In addition, the 5G CN may support dual-registration of the UE 106 on both a legacy network (e.g., LTE via a base station 202, such as an eNB) and a 5G network (e.g., via the base station 204). As shown, the base station 202 may have connections to a mobility management entity (MME) 242 and a serving gateway (SGW) 244. The MME 242 may have connections to both the SGW 244 and the AMF 205. In addition, the SGW 244 may have connections to both an SMF 206a and an UPF 208a. As shown, the AMF 205 may include one or more functional entities associated with the 5G CN (e.g., NSSF 220, SMSF 222, AF 224, UDM 226, PCF 228, and/or AUSF 230). The UDM 226 may also include a home subscriber server (HSS) function and the PCF 228 may also include a policy and charging rules function (PCRF). These functional entities may also be supported by an SMF 606a and an SMF 206b of the 5G CN. The AMF 206 may be connected to (or in communication with) the SMF 206a. Further, the base station 204 may be in communication with (or connected to) the UPF 208a that may also be in communication with the SMF 206a. Similarly, the N3IWF 203 may be communicating with a UPF 208b that may also be communicating with an SMF 206b. Both UPFs may be communicating with the data network (e.g., DN 210a and 210b) and/or the Internet 200 and an IMS core network 210.

In various embodiments, one or more of the above-described network entities may be configured to perform methods to improve security checks in a 5G NR network, including mechanisms for emergency communications (e.g., voice calls and/or SMS messages) for UEs without cellular coverage (e.g., in non-cellular coverage), e.g., as further described herein.

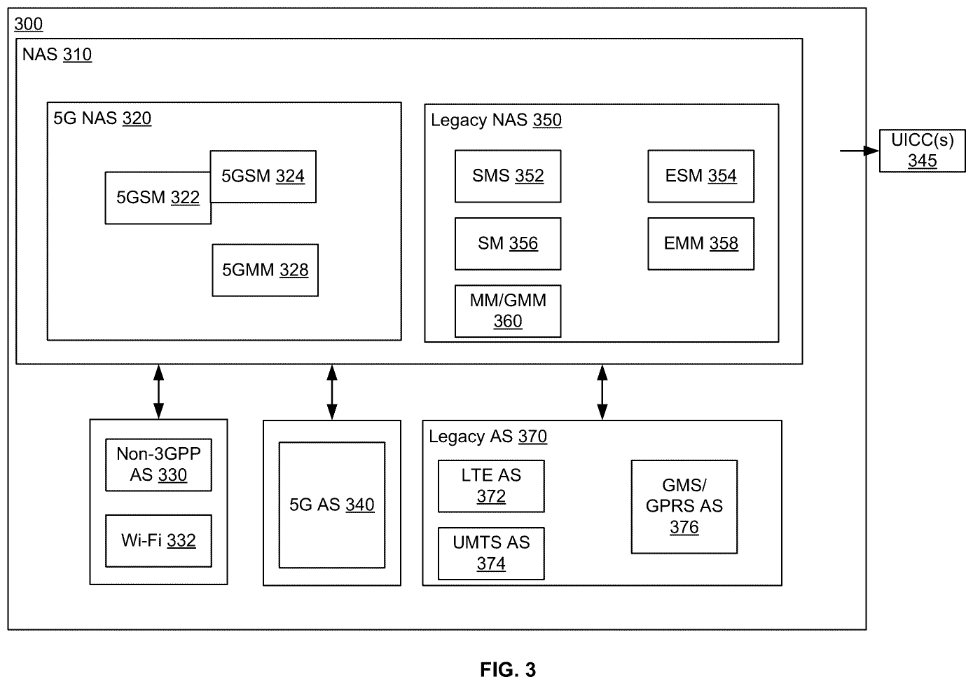

FIG. 3 illustrates an example of a baseband processor architecture for a UE 300 (e.g., the UE 106 and the UE 206), in accordance with some embodiments. The baseband processor architecture 300 described in FIG. 3 may be implemented on one or more radios or modems. As shown, a non-access stratum (NAS) 310 may include a 5G NAS 320 and a legacy NAS 350. The legacy NAS 350 may include a communication connection with a legacy access stratum (AS) 370. The 5G NAS 320 may include communication connections with both a 5G AS 340 and a non-3GPP AS 330 and Wi-Fi AS 332. The 5G NAS 320 may include functional entities associated with both access stratums. Thus, the 5G NAS 320 may include multiple 5G MM entities 326 and 328 and 5G session management (SM) entities 322 and 324. The legacy NAS 350 may include functional entities, such as short message service (SMS) entity 352, evolved packet system (EPS) session management (ESM) entity 354, session management (SM) entity 356, EPS mobility management (EMM) entity 358, and mobility management (MM)/GPRS mobility management (GMM) entity 360. In addition, the legacy AS 370 may include functional entities, such as LTE AS 372, UMTS AS 374, and/or GSM/GPRS AS 376.

Thus, the baseband processor architecture 300 allows for a common 5G-NAS for both 5G cellular and non-cellular (e.g., non-3GPP access). As shown, the 5G MM may maintain individual connection management and registration management state machines for each connection. Additionally, a device (e.g., UE 106) may register to a single public land mobile network (PLMN) using 5G cellular access as well as non-cellular access. Further, it may be possible for the device to be in a connected state in one access and an idle state in another access and vice versa. There may be common 5G-MM procedures (e.g., registration, de-registration, identification, authentication) for both accesses.

In various embodiments, one or more of the above-described functional entities of the 5G NAS and/or 5G AS may be configured to perform methods of emergency communications (e.g., voice calls and/or SMS messages) for UEs without cellular coverage (e.g., in non-cellular coverage), e.g., as further described herein.

As described herein above, a device group can be formed for the purpose of aggregating the devices of the group to provide an aggregated communication capability that corresponds to a collection of individual device communication capabilities. Referring back to FIGS. 1-3, this type of aggregation can be referred to as UE aggregation, where the aggregated communication capability represents an aggregated communication capability with a network (e.g., a 5G network). In particular, the aggregated communication capability enables the UEs to jointly communicate as a UE group with the network and enable the network to represent the UE group as a single endpoint to a component that does not belong to the group. The component can be an external network, another UE that communicates directly with the network, a computing service that communicates directly with the network or indirectly with the network (e.g., via the external network), and the like. The component is aware of the single endpoint without the need to have knowledge of the UEs. Inbound traffic from the component is directed to the single endpoint and the network distributes this inbound traffic to the UEs based on their individual device communication capabilities. Conversely, outbound traffic is received by the network from the multiple UEs based on their individual device communication capabilities and is funneled by the network to the component as if this outbound traffic originated from the single endpoint.

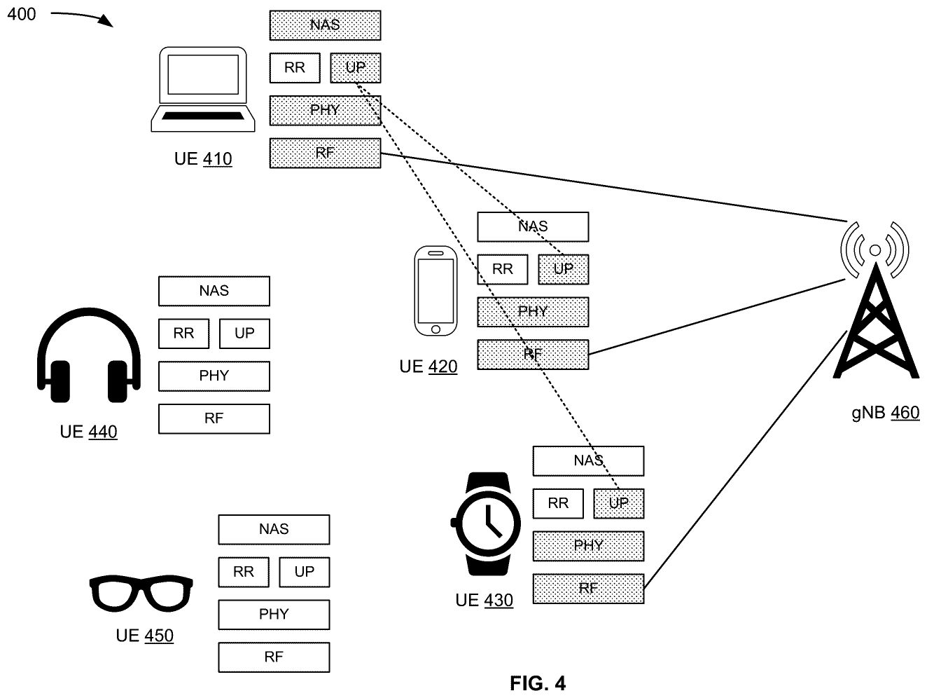

FIG. 4 illustrates an example of a UE aggregation 400, in accordance with some embodiments. Five UEs are illustrated: UE 410 (e.g., a laptop), UE 420 (e.g., a smartphone), UE 430 (e.g., a smart watch), UE 440 (e.g., a smart headphone), and UE 450 (e.g., smart glasses). Each one of the five UEs can communicate independently of the remaining four UEs with a network (e.g., a 5G network) by connecting to a gNB 460 (e.g., an example of a RAN). For instance, each one of the five UEs are subscribed with the network (e.g., a user account is registered with a provider of the network and is associated with the five UEs).

In the illustration of FIG. 4, the UE aggregation 400 involves grouping three out of the five UEs. In particular, the UE 410, the UE 420, and the UE 430 form a device group that supports the UE aggregation 400. The UE 440 and the UE 450 are not part of the device group and, as such, do not support the UE aggregation 400.

The three aggregated UEs 410, 420, and 430 combine their individual communication capabilities to function as a UE aggregate. In an example, these capabilities can be combined at a radio access level or at a higher level (e.g., NAS). At the radio access layer aggregation, capabilities, such as the number of supported component carriers (CCs), the maximum bit rate per CC, and the like are aggregated. For a higher layer aggregation, capabilities, such as the maximum number of protocol data unit (PDU) sessions supported, subscription settings (e.g., UE aggregate maximum bit rate (UE-AMBR)), and the like are aggregated.

Generally, the UE aggregation 400 also involves a group leader and a set of group members. In the illustration of FIG. 4, the group leader is the UE 410 (having its NAS active), whereas the UEs 420 and 430 are group member UEs (not having their NAS active with respect to the UE aggregation 400, although their NAS can be active for other purposes). Each UE 410, 420, and 430 of the UE aggregate can function independently (e.g., as a standalone UE) in the network for purposes other than the UE aggregation 400.

In an example, the network may apply restrictions on certain aggregated components (e.g., the UEs 410, 420, and 430 themselves or components thereof, such as radio components) for the purpose of the UE aggregation 400. There may be restrictions applied on certain components that can only function as part of a UE aggregate. For instance, millimeter wave (mmWave) communications may not be enabled for one of or all three UES 410, 420, and 430 unless the mmWave communications is used in the UE aggregation 400. Such restrictions may be subscription-based, network provider-based, user setting-based, and the like.

As shown in FIG. 4, to support the UE aggregation 400, aggregate communication resources may be needed and may handle mobility for the device group. These resources include, for instance, radio frequency (RF) resources, physical layer (PHY) resources, and multi-connectivity resources (e.g., user plane (UP) resources). Not all the radio resources of a UE need to be active for the UE to be able to support the UE aggregation 400. The aggregate communication resources are active during the UE aggregation 400 for the purpose of supporting the UE aggregation 400 and may be inactive otherwise or active for other purposes. In addition, because the UE 410 is the group leader, its NAS is active whereby controlling signaling with the network to the device group can be via the NAS of the group leader, rather than the NAS of the other group members. Here also, the NAS of the UE 410 is active for purposes of supporting the UE aggregation 400 and may be inactive otherwise or active for other purposes. Conversely, the NAS of each of the UEs 420 and 430 is inactive for the purposes of supporting the UE aggregation 400 and may be active for other purposes. The active resources are shown FIG. 4 with dotted rectangles, where inactive resources (for the purposes of the UE aggregation 400) are shown with blank rectangles. None of the resources of the UEs 440 and 450 are active (for the purposes of the UE aggregation 400) and, as such, these two UEs 440 and 450 are not part of the UE aggregation 400.

As further shown in FIG. 4, an active UE-network link may exist between each of the UEs 410, 420, and 430 of the device group (e.g., their RF resources) and the gNB 460. The UE-network links may include 5G RAN links and are illustrated with a solid line in FIG. 4. Further, an active inter-UE link may exist between each UE-UE pair of the device group (e.g., between their user plane resources). The inter-UE links may include 5G sidelink (NR PC5) or other radio access technology (RAT) links (e.g., BLUETOOTH, Wi-Fi) and are illustrated with dotted lines in FIG. 4.

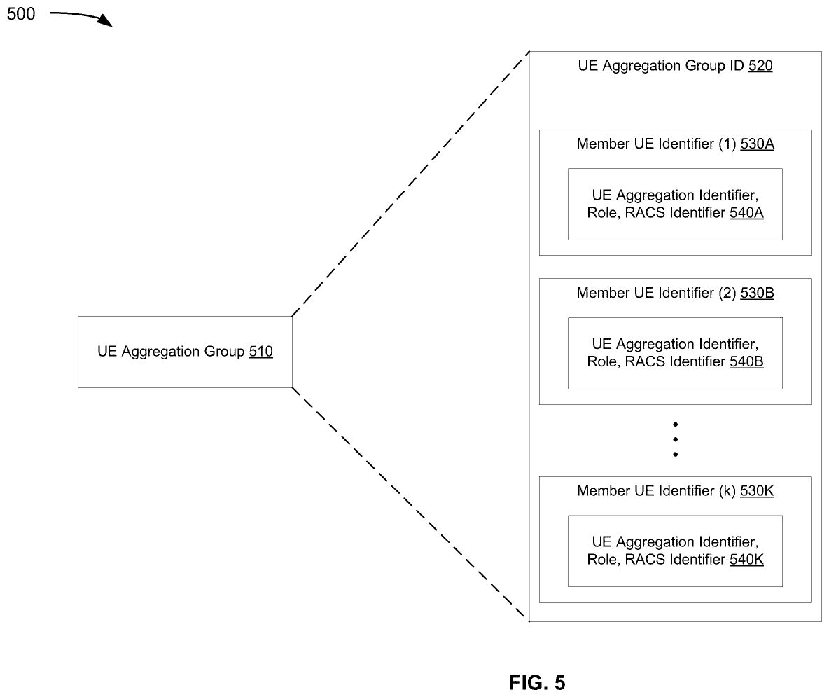

FIG. 5 illustrates an example of configuration information 500 for a UE aggregation, in accordance with some embodiments. The configuration information 500 can be stored using a particular data structure (e.g., a string, an array, a table) for a UE aggregation group 510 (e.g., the device group described in FIG. 4). The UE aggregation group 510 may be associated with a user account registered with a network provider. During production of each UE of the UE aggregation group 510, during subscription of each UE or a particular UE (e.g., the group leader) of the UE aggregation group 510 with the network, during the user account registration or setup, after the subscription or the user account registration/setup (e.g., based on over the air (OTA) update to the UEs and/or based on a user account update), the configuration information 500 may be generated and/or modified.

In an example, the configuration information 500 can include multiple parts: a part that the network stores and individual parts stored by each UE of the UE aggregation group 510. Here, the network-stored part is described. A UE-stored part can include some or all of the information of the network-stored part, as further described herein below.

In an example, the network-stored part identifies the UE aggregation group 510. For instance, the configuration information 500 includes a UE aggregation group identifier (ID) 520. The UE aggregation group ID 520 can be unique within the network to distinguish from other device groups. The network-stored part can also identify each UE that belongs to the UE aggregation group 510. For instance, the configuration information 500 includes a member UE identifier per UE. In the illustration of FIG. 4, the UE aggregation group 510 includes “K” UEs and, as such, the configuration information 500 includes “K” member UE identifiers (shown in FIG. 5 as member UE identifier (1) 530A, member UE identifier (2) 530B, . . . , member UE identifier (k) 530K). The network-stored part can also identify the role of each identified UE within the UE aggregation group 510. For instance, the configuration information 500 includes, as an attribute, a role corresponding to each UE. A role can be set to “group leader” or to “group member.” In certain use cases, the role of only one UE can be set to group leader, whereas the other UEs have their roles set to “group member.” Further, the network-stored part can also identify the set of communication capabilities that each identified UE support as part of the UE aggregation group 510. For instance, the configuration information 500 includes radio access capability signaling (RACS) identifier per UE of the UE aggregation group 510. In the illustration of FIG. 4, the UE aggregation group 510 includes “K” UEs and, as such, the configuration information 500 includes “K” roles and RACS identifiers (shown in FIG. 5 as role, RACs identifier 540A, role, RACs identifier 540B, . . . , role, RACs identifier 540K). The RACS ID for a UE within the UE aggregation group 510 can be a subset of UE Radio Capability that the UE wishes to contribute for UE aggregation. If the RACS ID is present, AMF can provide (e.g., to the NG-RAN) this information along with a UE context of the UE.

The network-stored part can be information stored in a unified data management (UDM) network function (NF) of the network. In an example, the UE aggregation group ID 520 includes an identifier that is part of the subscription. In comparison, a member UE identifier can include a subscription permanent identifier (SUPI), a globally unique temporary user equipment identifier (GUTI), such as a 5G-GUTI, a 5G temporary mobile subscriber identity (5G-TMSI), or a UE aggregation identifier.

Whereas the SUPI is a permanent identifier generated during subscription, the GUTI and TMSI can be dynamically generated in support of a dynamic group formation such that group members can only be identified if they are registered and have a 5G-GUTI/5G-TMSI or registered in the same AMF.

Relative to the GUTI/TMSI, the UE aggregation identifier can provide the most privacy and be the most dynamic in terms of when and how it is generated. For instance, the UE aggregation identifier can include unique identifier for each UE of the member UEs that can be aggregated. But this identifier need not be unique within the network. Further, the UE aggregation identifier cannot be used to trace back to the 5G-GUTI or SUPI of the UE. The format of the UE aggregation identifier can be based on the UE aggregation group ID 520 and the unique identifier. For instance, the format includes the UE aggregation group ID 520 and an “n-bit” unique UE identifier within the UE aggregation group 510. In addition to being stored in the UDM NF, a UE aggregation identifier of a UE can be stored in a universal subscriber identity module (USIM) of the UE.

In the illustration of FIG. 5, a nested approach can be used to associate the different types of information included in the configuration information 500. For instance, a UE aggregation identifier, role, and RACS identifier are nested within a member UE identifier, and member UE identifiers are nested within a UE aggregation group. Of course, nesting is one possible mechanism to associate the different types of information. Other association types are likewise possible.

As far as a UE-stored part of the configuration information 500, a UE can store its UE aggregation identifier in its USIM. Further, the UE can store the UE aggregation group ID 520 in its USIM. The remaining information described in connection with the network-stored part of the configuration can be optionally stored by the UE (e.g., in the USIM or another storage module). For example, the UE can further store its member UE identifier (if different from the UE aggregation identifier), its role, and/or its RACS identifier. Further, the UE can store the member UE identifier(s), the UE aggregation identifier(s) (if different from the member UE identifier(s)), role(s), and/or RACS identifier(s) of one or more of the other UEs of the UE aggregation group 510.

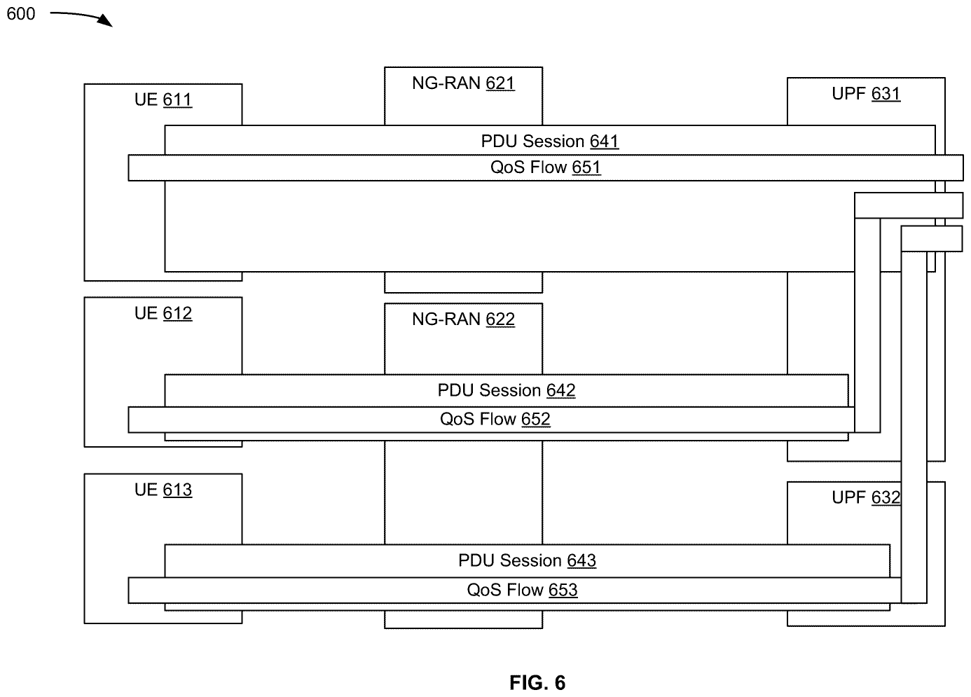

FIG. 6 illustrates an example of a quality of service (QoS) flow aggregation 600, in accordance with some embodiments. The QoS flow aggregation 600 is one example of aggregating communication capabilities of multiple UEs that form a UE aggregation group at a NAS level such that an aggregated communication capability is provided at the NAS level. Of course, other types of NAS level aggregation are possible.

In the illustration of FIG. 6, three UEs are included in the UE aggregation group: a UE 611, a UE 612, and a UE 613 (similar to the UEs 410, 420, and 430 of FIG. 4). The UE 611 can be configured as a group leader (e.g., by using configuration information similar to the configuration information 500 of FIG. 5). The UEs 611, 612, and 613 communicate with a network that includes a first NG-RAN 621 (e.g., a gNB), a second NG-RAN 622 (e.g., another gNB), a first UPF 631, and a second UPF 632.

In particular, the communication of the UE 611 with the network includes a first PDU session 641 between the UE 611 and the UPF 631, where the UE 611 accesses, at the radio level, the network via the NG-RAN 621. In comparison, the communication of the UE 612 with the network includes a second PDU session 642 between the UE 612 and the UPF 631, where the UE 612 accesses, at the radio level, the network via the NG-RAN 622. The communication of the UE 613 with the network includes a third PDU session 643 between the UE 613 and the UPF 632, where the UE 613 accesses, at the radio level, the network via the NG-RAN 622.

Absent the UE aggregation, three QoS flows may exist between the UE 611 and the network. In particular, the UE 611 is a first endpoint of the three QoS flows. A second endpoint of the three QoS flows may be within a core network of the network (e.g., a core network endpoint). The UPF 631 may connect (e.g., tunnel or otherwise) data (e.g., representing packets of the QoS flows) received from the UE 611 via the NG-RAN 621 to the second endpoint and vice versa.

During the UE aggregation, a first QoS flow 651 may exist between the first UE 611 and the second endpoint. This QoS flow 651 may be routed via the first PDU session 641 with the first UPF 631. Further, a second QoS flow 652 may exist between the second UE 612 (as a third endpoint) and the second endpoint. This QoS flow 652 may be routed in part via the second PDU session 642 and the first PDU session 641 with the first UPF 631. Similarly, a third QoS flow 653 may exist between the third UE 613 (as a fourth endpoint) and the second endpoint. This QoS flow 653 may be routed in part via the third PDU session 642 with the second UPF 632 and the first PDU session 641 with the first UPF 631.

As such, the three QoS flows 651, 652, and 653 are aggregated. From the perspective of the second endpoint (e.g., the core network endpoint), these QoS flows 651, 652, and 653 are routed via the first PDU session 641 with the first UPF 631. However, the three QoS flows 651, 652, and 653 are in fact routed, at least in part, via different PDU sessions to three different UEs 611, 612, and 613 that form a UE aggregation group.

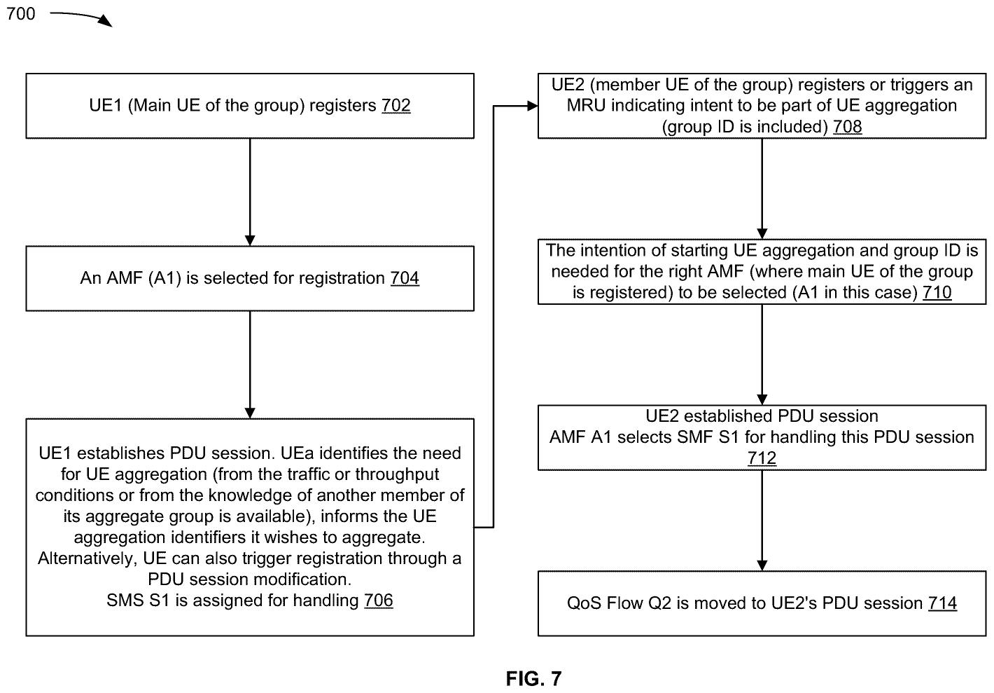

FIG. 7 illustrates an example of an operational flow/algorithmic structure 700 for a QoS flow aggregation, in accordance with some embodiments. In the interest of clarity of explanation, the operational flow/algorithmic structure 700 is described by referring back to the UE 611 and 612 of FIG. 6. Operations of the operational flow/algorithmic structure 700 can be similarly repeated for the UE 613 of FIG. 6 and/or any other UE that is part of the UE aggregation group. Here, and as in FIG. 6, the UE 611 is the leader device, whereas the UE 612 is a member device.

The operational flow/algorithmic structure 700 may include operation 702, where the UE 611 (shown as “UE1”) registers with the network. As part of the registration, the UE 611 may send the aggregation group ID to the network. At operation 704, the network may select an AMF (shown as “A1”) for the registration. At operation 706, the UE 611 may establish a PDU session (e.g., the first PDU session 641 with the UPF 631). The UE 611 also identifies the need for a UE aggregation. For instance, based on traffic or throughput conditions or from knowledge that another member of the UE aggregation group (e.g., the UE 612) is available (e.g., given signaling between such two UEs), the UE 611 informs the network that the UE 611 wishes to aggregate communication capabilities. The information sent to the network can include the UE aggregation identifier(s) of the UE 611, of the UE 612, and/or any other UE(s) of the UE aggregation group. Alternatively, the UE 611 can trigger the UE aggregation through a PDU session modification (e.g., if the first PDU session 631 is already established before the determination that the UE aggregation is to be performed, the PDU session modification can be used to modify the first PDU session 631 without the need to establish another PDU session). The network assigns an SMF (shown as “S1”) for handling this first PDU session. The first PDU session may be used for routing two QoS flows (e.g., the first QoS flow 651 and the second QoS flow 652)

At operation 708, the UE 612 (shown as “UE2”) also registers with the network or triggers a mobility registration update (MRU) with the network. The registration message or the MRU message indicates the intent of the UE 612 to be part of the UE aggregation group. For instance, the registration message or the MRU message can include the UE aggregation group ID. At operation 710, the network selects the same AMF (e.g., “A1”) to start the UE aggregation. That may be because, based on the group ID, the intention of starting the UE aggregation may need the right AMF (e.g., the AMF that was selected for the leader device of the UE aggregation group). At operation 712, the UE 612 established a PDU session (e.g., the second PDU session 642 with the UPF 631). And the selected AMF (e.g., “A1”) selects the same SMF (e.g., “S1”) for handling this second PDU session. At operation 714, the network (e.g., the AMF “A1”) moves the one of the two QoS flows (e.g., the QoS flow 652) to the UE's 612 PDU session (e.g., the second PDU session 642). The moving can include remapping the QoS flow to a different UPF core network tunnel and/or a different PSU session endpoint.

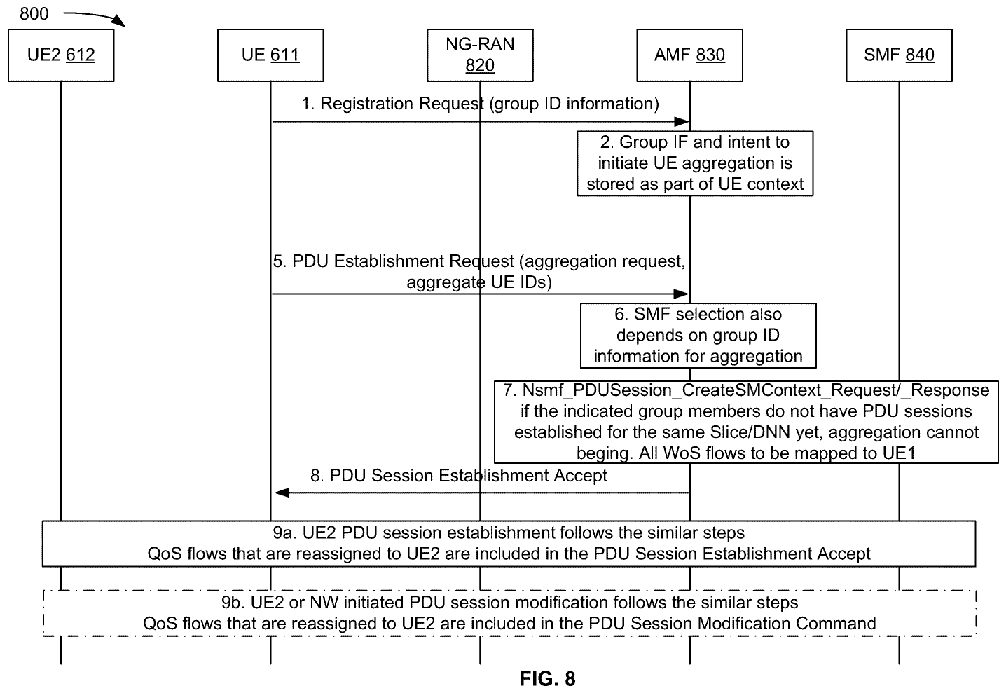

FIG. 8 illustrates an example of a sequence diagram 800 for a QoS flow aggregation, in accordance with some embodiments. Some or all the steps of the sequence diagram 800 can be implemented as part of the operational flow/algorithmic structure 700. Here also, sequence diagram 800 is described by referring back the UE 611 and 612 of FIG. 6. The steps of the sequence diagram 800 can be similarly repeated for the UE 613 of FIG. 6 and/or any other UE that is part of the UE aggregation group. Here, and as in FIG. 6, the UE 611 is the leader device, whereas the UE 612 is a member device.

In an example, the sequence diagram 800 may include the UE 611 registering with the network. The registering can include sending a registration request. In a 5G network, the registration request can be sent according to 3GPP TS23.502, V16.12.0 (2022 March), the content of which is herein incorporated by reference in its entirety, such as according to section 4.2.2.2. Further, the registration request can identify the UE aggregation group. For instance, the registration request can include group ID information (e.g., the UE aggregation group ID 520). An NG-RAN 820 (e.g., the gNB 460) can receive this request, select an AMF 830, and send the registration request to the AMF 830.

Next, the AMF can store information indicating an intent (or more generally a request or a trigger) to initiate a UE aggregation. This information can be stored as part of a UE context of the UE 611. The registration procedure per 3GPP TS23.502 can be completed and the AMF can send, via the NG-RAN 820, a registration accept to the UE 611. The registration accept can be a message that includes the group ID information. By including the group ID information, this message can indicate to the UE 611 that the UE aggregation group has been registered with the network.

Thereafter, the UE 612 can also perform a registration procedure with the network, similar to the one described herein above. Here also, the registration procedure can include sending a registration request that includes the group ID information.

At some point, the UE 611 can establish a PDU session with the network. For instance, the UE 611 can follow the PD establishment procedure described in section 4.3.2 of 3GPP TS23.502. In particular, the UE 611 sends a PDU establishment request, via the NG-RAN 820, to the AMF 830. Here, however, the PDU establishment request can further indicates that the UE aggregation requested and can identify a set or the entire group of UEs of the UE aggregation group that are to participate in the UE aggregation. For instance, the PDU session establishment request also includes an aggregation request and identifiers of such UEs. The identifiers can include SUPIs, GUTIs, TMSIs, and/or UE aggregation identifiers described herein above in connection with FIG. 5. Based on the PDU session establishment message, the AMF 830 selects an SMF 840 for the PDU session to be established. Here, the SMF selection can also depends on the group ID information for selection. For instance, the SMF 840 is selected given a capability of the SMF 540 to support the UE aggregation.

Next, the AMF 830 sends, to the SMF 840, a message to create a PDU session. For instance, the message represents an Nsmf_PDUSession_CreateContext Request that can include the UE context and/or the group ID information. In turn, the SMF 840 sends, to the AMF, a response about creating the PDU session. For instance, the response represents an Nsmf_PDUSession_CreateContext Response. Here, prior to sending the response, the SMF 840 can retrieve subscription information from the UDM. Based on the network-stored part of the configuration 500, the SMF 840 can determine the UEs that belong to the UR aggregation group. If these indicated group members (e.g., the UE 612) do not have PDU sessions established for the same slice and/or data network name (DNN), the UE aggregation cannot start yet. Instead, the SMF 840 determines that all the QoS flows (e.g., QoS flows 651 and 652) are to be mapped to the UE 611.

According to the response of the SMF 840, the AMF 830 sends a PDU establishment accept to the UE 611. As such, the PDU session of the UE 611 is established and the QoS flows are mapped to the UE 611.

The UE aggregation may start with the UE 612 establishing its own PDU session or, if this session is already established, by modifying the already established PDU session. In the former case, the UE 612 can follow a similar procedure as the one described above, whereby the UE 612 sends a PDU session establishment request that may include an aggregation request, the identifiers of the UEs that are to be part of the UE aggregation and/or the group ID information. In turn, the AMF 830 selects the same SMF 840 and sends a request thereto to create the PDU session. Next, the SMF 840 establishes the PDU session for the UE 612 and given the aggregation request, remaps at least one of the QoS flows (e.g., the QoS flow 652) to the UE 612. The remapping can be a reassignment that includes changing the endpoint of this QoS flow from being the UE 611 to being the UE 612. The SMF's 840 response to the AMF 830 can indicate the QoS flow(s) that are reassigned to the UE 612. The PDU session accept sent from the AMF 830 to the UE 612 can likewise indicate the reassigned QoS flow(s).

In the latter case, the UE 612 or the network can initiate a PDU session modification procedure (e.g., similar to the procedure in section 4.3.2 of 3GPP TS23.502) but may indicate the UE aggregation. For instance, a PDU session modification request can be sent, where this request may include an aggregation request, the identifiers of the UEs that are to be part of the UE aggregation and/or the group ID information. Given the aggregation request, the SMF 840 remaps at least one of the QoS flows (e.g., the QoS flow 652) to the UE 612. The SMF's 840 response to the AMF 830 can indicate the QoS flow(s) that are reassigned to the UE 612. The PDU session modification accept sent from the AMF 830 to the UE 612 can likewise indicate the reassigned QoS flow(s).

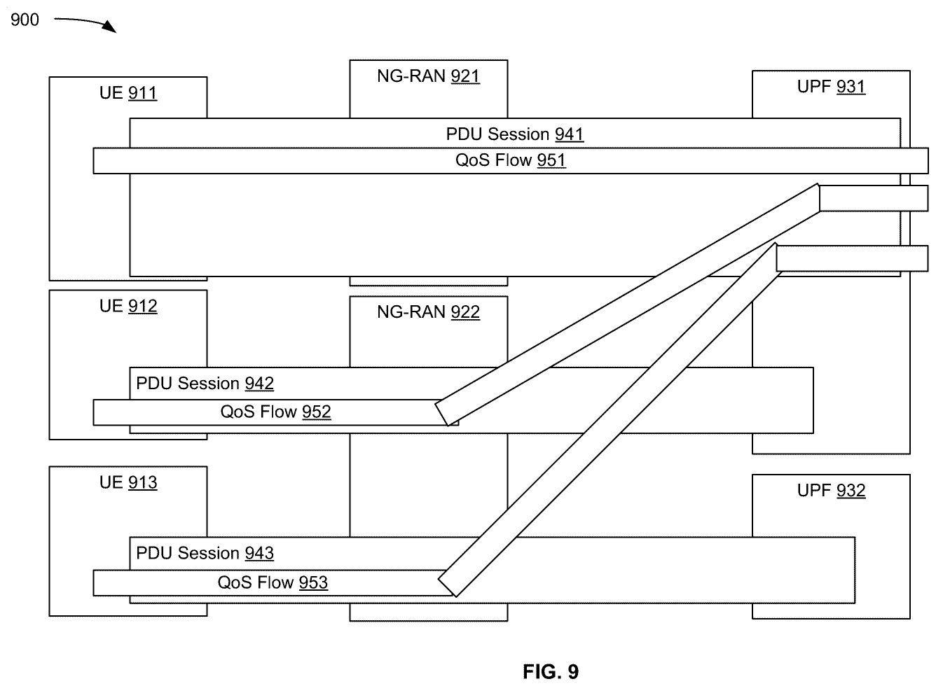

FIG. 9 illustrates an example of a RAN level aggregation 900, in accordance with some embodiments. The RAN level aggregation 900 is one example of aggregating communication capabilities of multiple UEs that form a UE aggregation group at a RAN level. Of course, other types of RAN level aggregation are possible.

In the illustration of FIG. 9, three UEs are included in the UE aggregation group: a UE 911, a UE 912, and a UE 913 (similar to the UEs 410, 420, and 430 of FIG. 4). The UE 911 can be configured as a group leader (e.g., by using configuration information similar to the configuration information 500 of FIG. 5). The UEs 911, 912, and 913 communicate with a network that includes a first NG-RAN 921 (e.g., a gNB), a second NG-RAN 922 (e.g., another gNB), a first UPF 931, and a second UPF 932.

In particular, the communication of the UE 911 with the network includes a first PDU session 941 between the UE 911 and the UPF 931, where the UE 911 accesses, at the radio level, the network via the NG-RAN 921. In comparison, the communication of the UE 912 with the network includes a second PDU session 942 between the UE 912 and the UPF 931, where the UE 912 accesses, at the radio level, the network via also the NG-RAN 921. The communication of the UE 913 with the network includes a third PDU session 943 between the UE 913 and the UPF 932, where the UE 913 accesses, at the radio level, the network via the NG-RAN 922.

Absent the UE aggregation, three QoS flows may exist between the UE 911 and the network. In particular, the UE 911 is a first endpoint of the three QoS flows. A second endpoint of the three QoS flows may be within a core network of the network (e.g., a core network endpoint). The UPF 931 may connect (e.g., tunnel or otherwise) data (e.g., representing packets of the QoS flows) received from the UE 911 via the NG-RAN 921 to the second endpoint and vice versa.

During the UE aggregation, a first QoS flow 951 may exist between the first UE 911 and the second endpoint. This QoS flow 951 may be routed by the first NG-RAN 921 via the first PDU session 941 with the first UPF 931. Further, a second QoS flow 952 may exist between the second UE 912 (as a third endpoint) and the second endpoint. This QoS flow 952 may be routed by the second NG-RAN 922 in part via the second PDU session 942 and the first PDU session 941 with the first UPF 931. Similarly, a third QoS flow 953 may exist between the third UE 913 (as a fourth endpoint) and the second endpoint. This QoS flow 953 may be routed by the second NG-RAN 922 in part via the third PDU session 942 with the second UPF 932 and the first PDU session 941 with the first UPF 931. In this illustration, the second NG-RAN 922 has knowledge that non-aggregated QoS flows of the second UE 912 and/or the UE 913 have certain core network endpoints, whereas the aggregated QoS flows 952 and 953 have a different core network endpoint (e.g., the second endpoint).

As such, the three QoS flows 951, 952, and 953 are aggregated. From the perspective of the second endpoint (e.g., the core network endpoint), these QoS flows 951, 952, and 953 are routed via the first PDU session 941 with the first UPF 931. However, the three QoS flows 951, 952, and 953 are in fact routed, at least in part, by different NG-RANs via different PDU sessions to three different UEs 911, 912, and 913 that form a UE aggregation group.

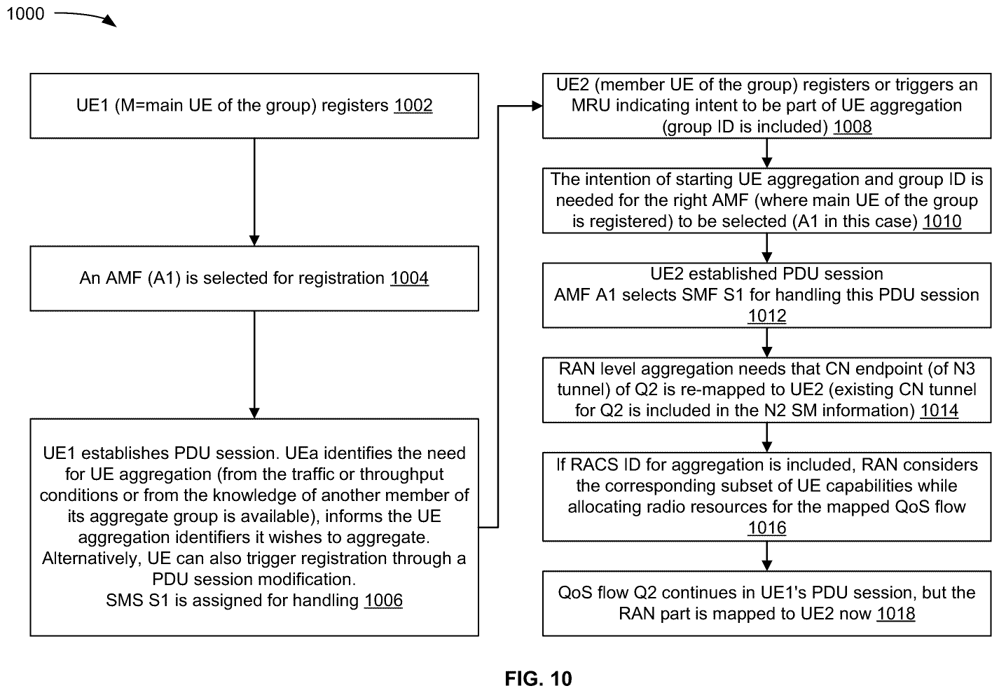

FIG. 10 illustrates an example of an operational flow/algorithmic structure 1000 for a RAN level aggregation, in accordance with some embodiments. In the interest of clarity of explanation, the operational flow/algorithmic structure 1000 is described by referring back to the UE 911 and 912 of FIG. 9. Operations of the operational flow/algorithmic structure 1000 can be similarly repeated for the UE 913 of FIG. 9 and/or any other UE that is part of the UE aggregation group. Here, and as in FIG. 9, the UE 911 is the leader device, whereas the UE 912 is a member device.

The operational flow/algorithmic structure 1000 may include operation 1002, where the UE 911 (shown as “UE1”) registers with the network. As part of the registration, the UE 911 may send the aggregation group ID to the network. At operation 1004, the network may select an AMF (shown as “A1”) for the registration. At operation 1006, the UE 911 may establish a PDU session (e.g., the first PDU session 941 with the UPF 931). The UE 911 also identifies the need for a UE aggregation. For instance, based on traffic or throughput conditions or from knowledge that another member of the UE aggregation group (e.g., the UE 912) is available (e.g., given signaling between such two UEs), the UE 911 informs the network that the UE 911 wishes to aggregate communication capabilities. The information sent to the network can include the UE aggregation identifier(s) of the UE 911, of the UE 912, and/or any other UE(s) of the UE aggregation group. Alternatively, the UE 911 can trigger the UE aggregation through a PDU session modification (e.g., if the first PDU session 931 is already established before the determination that the UE aggregation is to be performed, the PDU session modification can be used to modify the first PDU session 931 without the need to establish another PDU session). The network assigns an SMF (shown as “S1”) for handling this first PDU session. The first PDU session may be used for routing two QoS flows (e.g., the first QoS flow 951 and the second QoS flow 952)

At operation 1008, the UE 912 (shown as “UE2”) also registers with the network or triggers a mobility registration update (MRU) with the network. The registration message or the MRU message indicates the intent of the UE 912 to be part of the UE aggregation group. For instance, the registration message or the MRU message can include the UE aggregation group ID. At operation 1010, the network selects the same AMF (e.g., “A1”) to start the UE aggregation. That may be because, based on the group ID, the intention of starting the UE aggregation may need the right AMF (e.g., the AMF that was selected for the leader device of the UE aggregation group). At operation 1012, the UE 912 established a PDU session (e.g., the second PDU session 942 with the UPF 931). And the selected AMF (e.g., “A1”) selects the same SMF (e.g., “S1”) for handling this second PDU session.

At operation 1014, for the RAN level aggregation to be successful, a QoS flow needs to be remapped from the UE 911 to the UE 912. As such, the network can remap the core network endpoint (e.g., of an N3 tunnel) of this QoS flow to the UE 912. The existing cornet work tunnel information is included in the N2 SM information that is sent to the NG-RAN 922 (e.g., N2 SM information being the information forwarded by the AMF “A1”). the core network endpoint of the NG-RAN (e.g., the NG-RAN 922).

At operation 1016, if the RACS identifier for the UE aggregation is included, the NG-RAN 922 determines the UE capabilities of the UE 912 based on the RACS identifier. These capabilities correspond to the subset of the all UE capabilities, where the UE 912 supports this subset for the UE aggregation. The NG-RAN 922 considers the subset of UE capabilities while allocating radio resources for the mapped QoS flow. At operation 1018, the QoS flow (e.g., the QoS flow 952) continues in the UE's 911 PDU session, but the RAN part is now mapped to the UE 912.

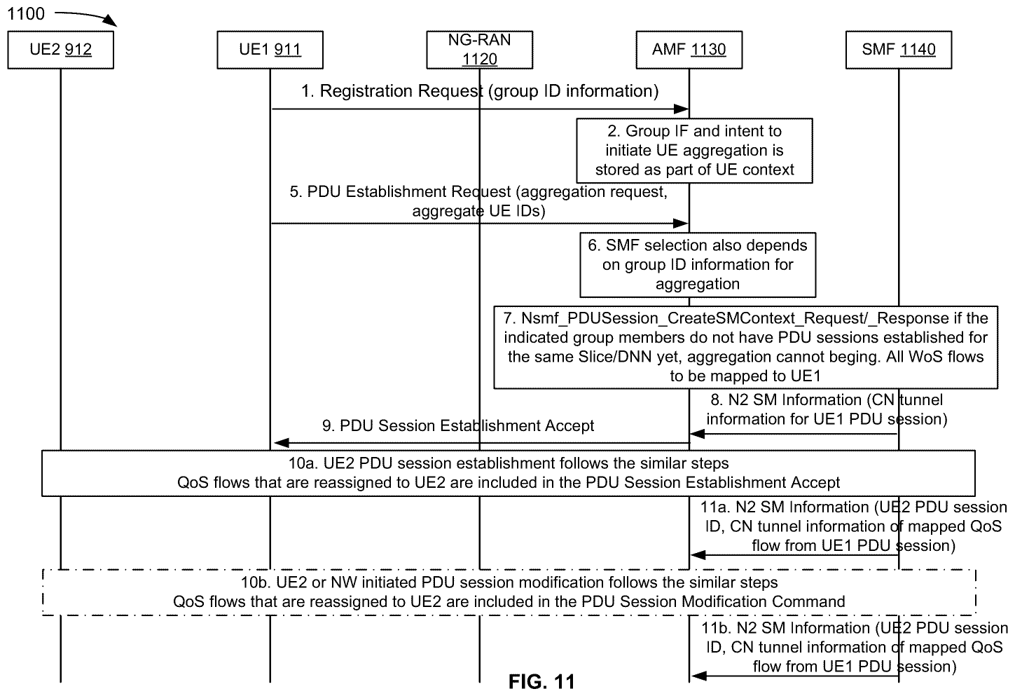

FIG. 11 illustrates an example of a sequence diagram 1100 for a RAN level aggregation, in accordance with some embodiments. Some or all the steps of the sequence diagram 1100 can be implemented as part of the operational flow/algorithmic structure 1000. Here also, sequence diagram 1100 is described by referring back the UE 911 and 912 of FIG. 9. The steps of the sequence diagram 1100 can be similarly repeated for the UE 913 of FIG. 9 and/or any other UE that is part of the UE aggregation group. Here, and as in FIG. 9, the UE 911 is the leader device, whereas the UE 912 is a member device.

In an example, the sequence diagram 1100 may include the UE 911 registering with the network. The registering can include sending a registration request. In a 5G network, the registration request can be sent according to 3GPP TS23.502, such as according to section 4.2.2.2. Further, registration request can identify the UE aggregation group. For instance, the registration request can include group ID information (e.g., the UE aggregation group ID 520). An NG-RAN 1120 (e.g., the gNB 460) can receive this request, select an AMF 1130, and send the registration request to the AMF 1130.

Next, the AMF can store information indicating an intent (or more generally a request or a trigger) to initiate a UE aggregation. This information can be stored as part of a UE context of the UE 911. The registration procedure per 3GPP TS23.502 can be completed and the AMF can send, via the NG-RAN 1120, a registration accept to the UE 911. The registration accept can be a message that includes the group ID information. By including the group ID information, this message can indicate to the UE 911 that the UE aggregation group has been registered with the network.

Thereafter, the UE 912 can also perform a registration procedure with the network, similar to the one described herein above. Here also, the registration procedure can include sending a registration request that includes the group ID information.

At some point, the UE 911 can establish a PDU session with the network. For instance, the UE 911 can follow the PD establishment procedure described in section 4.3.2 of 3GPP TS23.502. In particular, the UE 911 sends a PDU establishment request, via the NG-RAN 1120, to the AMF 1130. Here, however, the PDU establishment request can further indicates that the UE aggregation requested and can identify a set or the entire group of UEs of the UE aggregation group that are to participate in the UE aggregation. For instance, the PDU session establishment request also includes an aggregation request and identifiers of such UEs. The identifiers can include SUPIs, GUTIs, TMSIs, and/or UE aggregation identifiers described herein above in connection with FIG. 5. Based on the PDU session establishment message, the AMF 1130 selects an SMF 1140 for the PDU session to be established. Here, the SMF selection can also depends on the group ID information for selection. For instance, the SMF 1140 is selected given a capability of the SMF 540 to support the UE aggregation.

Next, the AMF 1130 sends, to the SMF 1140, a message to create a PDU session. For instance, the message represents an Nsmf_PDUSession_CreateContext Request that can include the UE context and/or the group ID information. In turn, the SMF 1140 sends, to the AMF, a response about creating the PDU session. For instance, the response represents an Nsmf_PDUSession_CreateContext Response. Here, prior to sending the response, the SMF 1140 can retrieve subscription information from the UDM. Based on the network-stored part of the configuration 500, the SMF 1140 can determine the UEs that belong to the UR aggregation group. If these indicated group members (e.g., the UE 912) do not have PDU sessions established for the same slice and/or data network name (DNN), the UE aggregation cannot start yet. Instead, the SMF 1140 determines that all the QoS flows (e.g., QoS flows 951 and 952) are to be mapped to the UE 911.

According to the response of the SMF 1140, the AMF 1130 sends N2 session management (SM) information to the NG-RAN 1120. This N2 SM information includes the core network tunnel information for the UE's 911 PDU session. The AMF 1130 also sends a PDU establishment accept to the UE 911. As such, the PDU session of the UE 911 is established and the QoS flows are mapped to the UE 911.

The UE aggregation may start with the UE 912 establishing its own PDU session or, if this session is already established, by modifying the already established PDU session. In the former case, the UE 912 can follow a similar procedure as the one described above, whereby the UE 912 sends a PDU session establishment request that may include an aggregation request, the identifiers of the UEs that are to be part of the UE aggregation and/or the group ID information. In turn, the AMF 1130 selects the same SMF 1140 and sends a request thereto to create the PDU session. Next, the SMF 1140 establishes the PDU session for the UE 912 and given the aggregation request, remaps at least one of the QoS flows (e.g., the QoS flow 952) to the UE 912. The remapping can be a reassignment that includes changing the endpoint of this QoS flow from being the UE 911 to being the UE 912. The SMF's 1140 response to the AMF 1130 can indicate the QoS flow(s) that are reassigned to the UE 912. The PDU session accept sent from the AMF 1130 to the UE 912 can likewise indicate the reassigned QoS flow(s). Further, the AMF 1130 sends N2 SM information to the NG-RAN 1120 indicating that this UE's 912 PDU session is mapped to the UE's 911 PDU session. For instance, the N2 information includes a PDUSessionID of the UE's 912 PDU session (e.g., the second PDU session 952), a core network tunnel information of mapped QoS flows from the UE's 911 PDU session (e.g., the first PDU session 951).

In the latter case, the UE 912 or the network can initiate a PDU session modification procedure (e.g., similar to the procedure in section 4.3.2 of 3GPP TS23.502) but may indicate the UE aggregation. For instance, a PDU session modification request can be sent, where this request may include an aggregation request, the identifiers of the UEs that are to be part of the UE aggregation and/or the group ID information. Given the aggregation request, the SMF 1140 remaps at least one of the QoS flows (e.g., the QoS flow 952) to the UE 912. The SMF's 1140 response to the AMF 1130 can indicate the QoS flow(s) that are reassigned to the UE 912. The PDU session modification accept sent from the AMF 1130 to the UE 912 can likewise indicate the reassigned QoS flow(s). Here also, the AMF 1130 sends N2 SM information to the NG-RAN 1120 indicating that this UE's 912 PDU session is mapped to the UE's 911 PDU session. For instance, the N2 information includes a PDUSessionID of the UE's 912 PDU session (e.g., the second PDU session 952), a core network tunnel information of mapped WoS flows from the UE's 911 PDU session (e.g., the first PDU session 951).

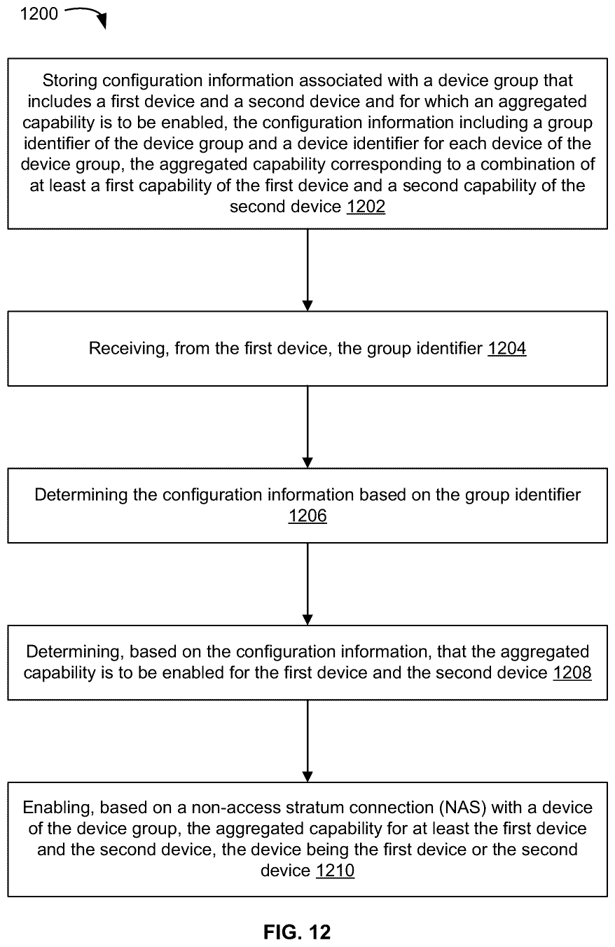

FIG. 12 illustrates an example of an operational flow/algorithmic structure 1200 for a network to participate in a UE aggregation, in accordance with some embodiments. In an example, the network can include a 5G network, such as the one described in connection with FIGS. 1-2. Components of the network, such as a NG-RAN, AMF, SMF, and UDM can execute the operational flow/algorithmic structure 1200.

The operation flow/algorithmic structure 1200 may include, at 1202, storing configuration information associated with a device group that includes a first device and a second device and for which an aggregated communication capability is to be enabled, the configuration information including a group identifier of the device group and a device identifier for each device of the device group, the aggregated communication capability corresponding to a combination of at least a first communication capability of the first device with the network and a second communication capability of the second device with the network. For instance, the configuration information can be an example of the configurator information 500. The network-stored part of the configuration information 500 can be stored in a UDM of the network.

The operation flow/algorithmic structure 1200 may include, at 1204, receiving, from the first device, the group identifier. For instance, the first device is a group leader. In this case, the group identifier can be received in a registration request message. Alternatively, the first device is a group member. In also this case, the group identifier can be received in a registration request message.

The operation flow/algorithmic structure 1200 may include, at 1206, determining the configuration information based on the group identifier. For instance, the information stored by the UDM is looked up using the group identifier to retrieve the configuration information.

The operation flow/algorithmic structure 1200 may include, at 1208, determining, based on the configuration information, that the aggregated communication capability is to be enabled for the first device and the second device. For instance, the retrieved information can indicate that the two devices are part of the device group and that this device group is subscribed to support a particular set of communication capabilities.

The operation flow/algorithmic structure 1200 may include, at 1210, enabling, based on a NAS with a device of the device group, the aggregated communication capability for at least the first device and the second device, the device being the first device or the second device. For instance, the device is the first device if the first device is the group leader. Enabling the aggregated communication capability can include establishing data connection with the two devices, where these data connections can include PDU sessions and QoS flows, and, as applicable, re-mapping QoS flows to the two devices and informing NG-RANs about the remapping as described herein above in FIGS. 6-11.

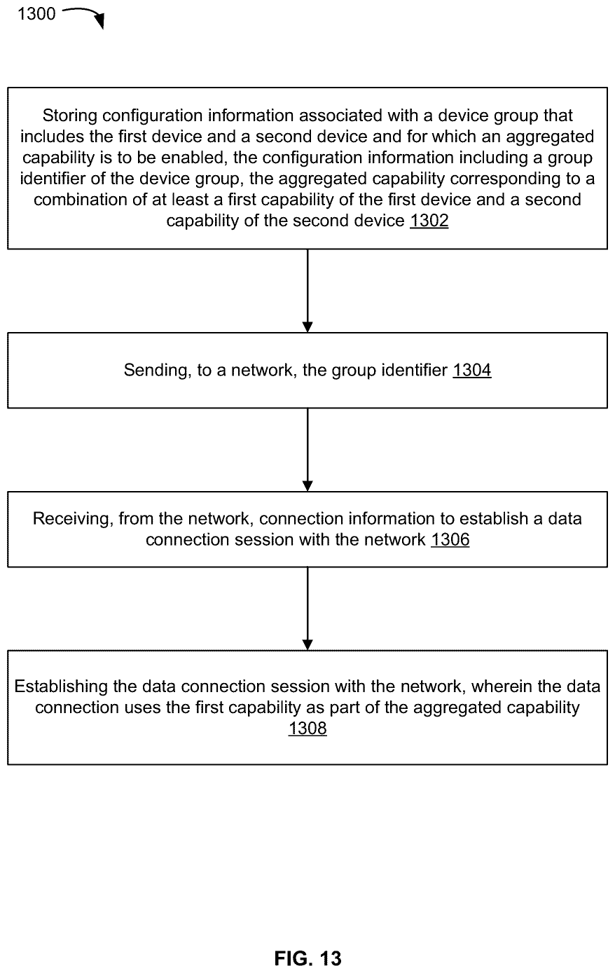

FIG. 13 illustrates an example of an operational flow/algorithmic structure 1300 for a UE to participate in UE aggregation, in accordance with some embodiments. In an example, the UE is a first device capable of communicating with a 5G network, such as the one described in connection with FIGS. 1-3 or FIG. 15. Components of the UE, such as processors 1504 can execute the operational flow/algorithmic structure 1300.

The operation flow/algorithmic structure 1300 may include, at 1302, storing configuration information associated with a device group that includes the first device and a second device and for which an aggregated communication capability is to be enabled, the configuration information including a group identifier of the device group, the aggregated communication capability corresponding to a combination of at least a first communication capability of the first device with a network and a second communication capability of the second device with the network. For instance, the configuration information can be an example of the configurator information 500. The UE-stored part of the configuration information 500 can be stored in a USIM and/or a storage module of the UE

The operation flow/algorithmic structure 1300 may include, at 1304, sending, to the network, the group identifier. For instance, the first device is a group leader. In this case, the group identifier can be sent in a registration request message. Alternatively, the first device is a group member. In also this case, the group identifier can be sent in a registration request message.

The operation flow/algorithmic structure 1300 may include, at 1306, receiving, from the network, connection information to establish a data connection session with the network. For instance, the data connection can include a PDU session, where the information is received in a PDU session accept message or a PDU session modification command.

The operation flow/algorithmic structure 1300 may include, at 1308, establishing the data connection session with the network, wherein the data connection uses the first communication capability as part of the aggregated communication capability. For instance, a QoS flow to the first device can be re-mapped from a QoS flow of the second device, or vice versa, and/or can be re-routed, at a radio access level, via a different NG-RAB as described herein above in FIGS. 6-11.

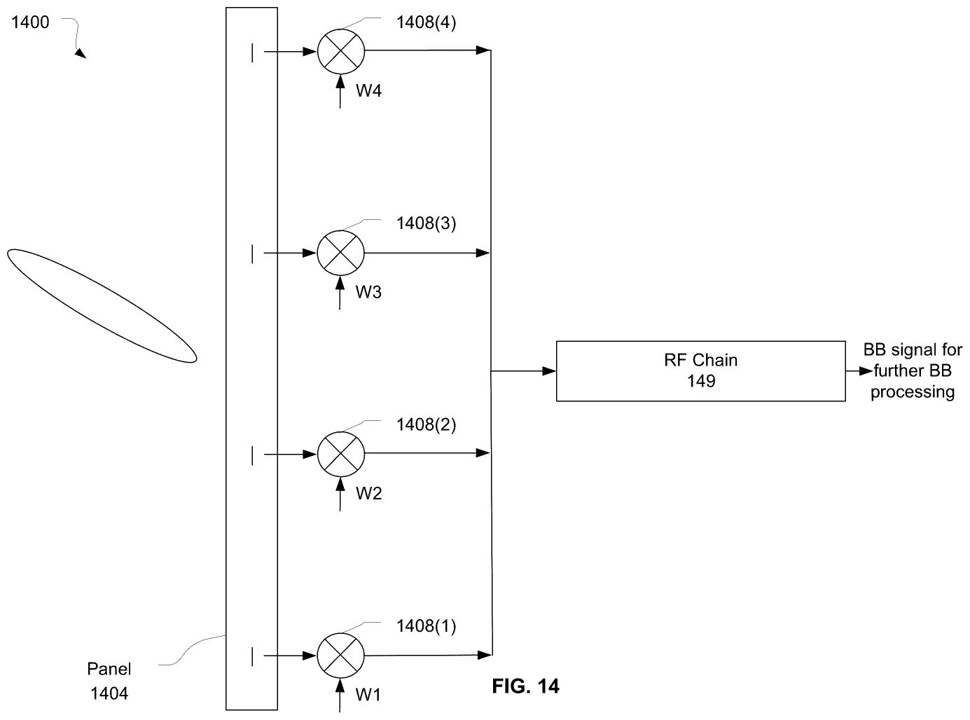

FIG. 14 illustrates receive components 1400 of the UE 106, in accordance with some embodiments. The receive components 1400 may include an antenna panel 1404 that includes a number of antenna elements. The panel 1404 is shown with four antenna elements, but other embodiments may include other numbers.

The antenna panel 1404 may be coupled to analog beamforming (BF) components that include a number of phase shifters 1408(1)-1408(4). The phase shifters 1408(1)-1408(4) may be coupled with a radio-frequency (RF) chain 1412. The RF chain 1412 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 1408(1)-1408(4) to provide a receive beam at the antenna panel 1404. These BF weights may be determined based on the channel-based beamforming.

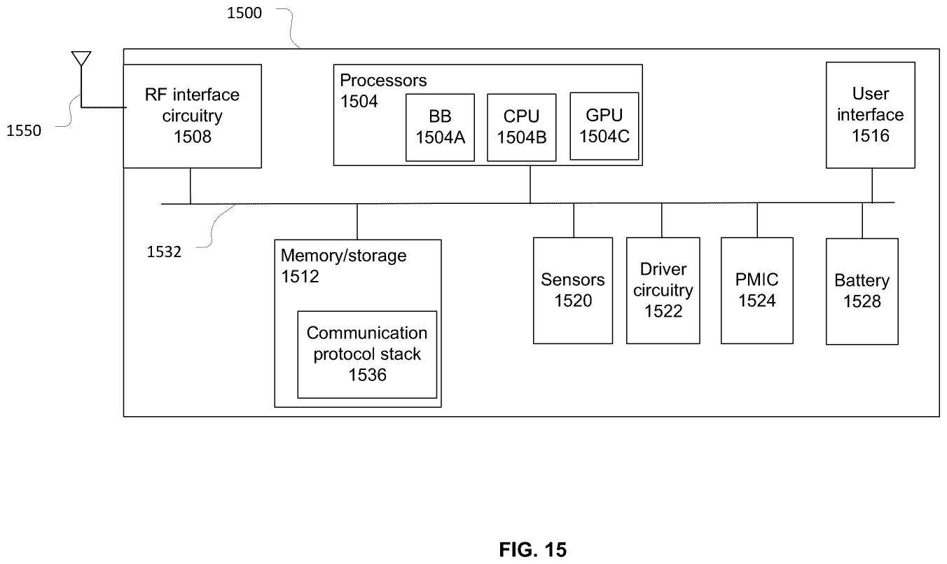

FIG. 15 illustrates a UE 1500, in accordance with some embodiments. The UE 1500 may be similar to and substantially interchangeable with UE 106 of FIG. 1.

Similar to that described above with respect to UE 106, the UE 1500 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras, and video cameras), wearable devices, or relaxed-IoT devices. In some embodiments, the UE may be a reduced capacity UE or NR-Light UE.

The UE 1500 may include processors 1504, RF interface circuitry 1508, memory/storage 1512, user interface 1516, sensors 1520, driver circuitry 1522, power management integrated circuit (PMIC) 1524, and battery 1528. The components of the UE 1500 may be implemented as integrated circuits (ICs), portions thereof, discrete electronic devices, or other modules, logic, hardware, software, firmware, or a combination thereof. The block diagram of FIG. 15 is intended to show a high-level view of some of the components of the UE 1500. However, some of the components shown may be omitted, additional components may be present, and different arrangements of the components shown may occur in other implementations.

The components of the UE 1500 may be coupled with various other components over one or more interconnects 1532, which may represent any type of interface, input/output, bus (local, system, or expansion), transmission line, trace, optical connection, etc. that allows various circuit components (on common or different chips or chipsets) to interact with one another.

The processors 1504 may include processor circuitry, such as baseband processor circuitry (BB) 1504A, central processor unit circuitry (CPU) 1504B, and graphics processor unit circuitry (GPU) 1504C. The processors 1504 may include any type of circuitry or processor circuitry that executes or otherwise operates computer-executable instructions, such as program code, software modules, or functional processes from memory/storage 1512 to cause the UE 1500 to perform operations as described herein.

In some embodiments, the baseband processor circuitry 1504A may access a communication protocol stack 1536 in the memory/storage 1512 to communicate over a 3GPP compatible network. In general, the baseband processor circuitry 1504A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1508.

The baseband processor circuitry 1504A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1504A may also access group information 1524 from memory/storage 1512 to determine search space groups in which a number of repetitions of a PDCCH may be transmitted.

The memory/storage 1512 may include any type of volatile or non-volatile memory that may be distributed throughout the UE 1500. In some embodiments, some of the memory/storage 1512 may be located on the processors 1504 themselves (for example, L1 and L2 cache), while other memory/storage 1512 is external to the processors 1504 but accessible thereto via a memory interface. The memory/storage 1512 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 1508 may include transceiver circuitry and a radio frequency front module (RFEM) that allows the UE 1500 to communicate with other devices over a radio access network. The RF interface circuitry 1508 may include various elements arranged in transmit or receive paths. These elements may include, for example, switches, mixers, amplifiers, filters, synthesizer circuitry, and/or control circuitry.

In the receive path, the RFEM may receive a radiated signal from an air interface via an antenna 1550 and proceed to filter and amplify (with a low-noise amplifier) the signal. The signal may be provided to a receiver of the transceiver that down-converts the RF signal into a baseband signal that is provided to the baseband processor of the processors 1504.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1550.

In various embodiments, the RF interface circuitry 1508 may be configured to transmit/receive signals in a manner compatible with NR access technologies.

The antenna 1550 may include a number of antenna elements that each convert electrical signals into radio waves to travel through the air and to convert received radio waves into electrical signals. The antenna elements may be arranged into one or more antenna panels. The antenna 1550 may have antenna panels that are omnidirectional, directional, or a combination thereof to enable beamforming and multiple input, multiple output communications. The antenna 1550 may include microstrip antennas, printed antennas fabricated on the surface of one or more printed circuit boards, patch antennas, phased array antennas, etc. The antenna 1550 may have one or more panels designed for specific frequency bands including bands in FR1 or FR2.

The user interface circuitry 1516 includes various input/output (I/O) devices designed to enable user interaction with the UE 1500. The user interface 1516 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs, or more complex outputs, such as display devices or touchscreens (for example, liquid crystal displays (LCDs), LED displays, quantum dot displays, projectors), with the output of characters, graphics, multimedia objects, and the like being generated or produced from the operation of the UE 1500.

The sensors 1520 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1522 may include software and hardware elements that operate to control particular devices that are embedded in the UE 1500, attached to the UE 1500, or otherwise communicatively coupled with the UE 1500. The driver circuitry 1522 may include individual drivers allowing other components to interact with or control various input/output (I/O) devices that may be present within, or connected to, the UE 1500. For example, driver circuitry 1522 may include a display driver to control and allow access to a display device, a touchscreen driver to control and allow access to a touchscreen interface, sensor drivers to obtain sensor readings of sensor circuitry 1520 and control and allow access to sensor circuitry 1520, drivers to obtain actuator positions of electro-mechanic components or control and allow access to the electro-mechanic components, a camera driver to control and allow access to an embedded image capture device, audio drivers to control and allow access to one or more audio devices.

The PMIC 1524 may manage power provided to various components of the UE 1500. In particular, with respect to the processors 1504, the PMIC 1524 may control power-source selection, voltage scaling, battery charging, or DC-to-DC conversion.

In some embodiments, the PMIC 1524 may control, or otherwise be part of, various power saving mechanisms of the UE 1500. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1500 may power down for brief intervals of time and thus save power. If there is no data traffic activity for an extended period of time, then the UE 1500 may transition off to an RRC_Idle state, where it disconnects from the network and does not perform operations, such as channel quality feedback and/or handover. The UE 1500 goes into a very low power state and it performs paging where again it periodically wakes up to listen to the network and then powers down again. The UE 1500 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1528 may power the UE 1500, although in some examples the UE 1500 may be mounted deployed in a fixed location, and may have a power supply coupled to an electrical grid. The battery 1528 may be a lithium ion battery, a metal-air battery, such as a zinc-air battery, an aluminum-air battery, a lithium-air battery, and the like. In some implementations, such as in vehicle-based applications, the battery 1528 may be a typical lead-acid automotive battery.

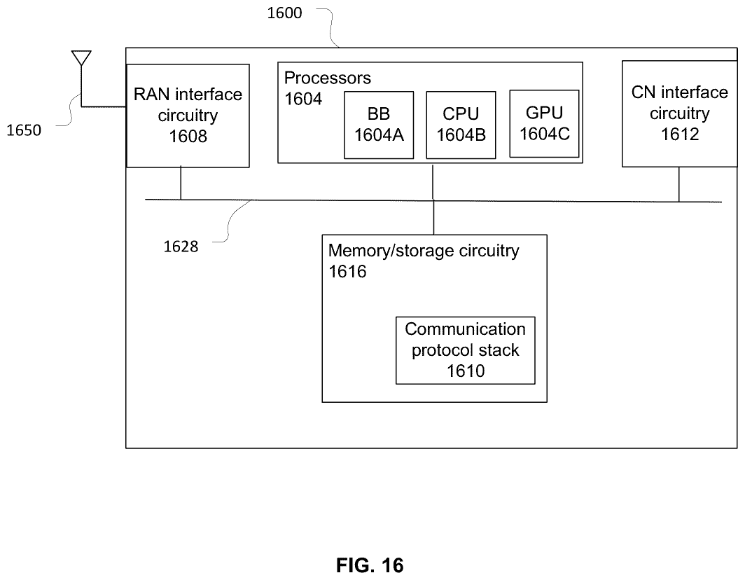

FIG. 16 illustrates a gNB 1600, in accordance with some embodiments. The gNB node 1600 may be similar to and substantially interchangeable with the base station 104 of FIG. 1.

The gNB 1600 may include processors 1604, RF interface circuitry 1608, core network (CN) interface circuitry 1612, and memory/storage circuitry 1616.

The components of the gNB 1600 may be coupled with various other components over one or more interconnects 1628.

The processors 1604, RF interface circuitry 1608, memory/storage circuitry 1616 (including communication protocol stack 1610), antenna 1650, and interconnects 1628 may be similar to like-named elements shown and described with respect to FIG. 10.

The CN interface circuitry 1612 may provide connectivity to a core network, for example, a Fifth Generation Core network (5GC) using a 5GC-compatible network interface protocol, such as carrier Ethernet protocols, or some other suitable protocol. Network connectivity may be provided to/from the gNB 1600 via a fiber optic or wireless backhaul. The CN interface circuitry 1612 may include one or more dedicated processors or FPGAs to communicate using one or more of the aforementioned protocols. In some implementations, the CN interface circuitry 1612 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, and/or network element as described above in connection with one or more of the preceding figures may be configured to operate in accordance with one or more of the examples set forth below in the example section.

### Examples

In the following sections, further exemplary embodiments are provided.

Example 1 includes a method implemented by a network, the method comprising: storing configuration information associated with a device group that includes a first device and a second device and for which an aggregated communication capability is to be enabled, the configuration information including a group identifier of the device group and a device identifier for each device of the device group, the aggregated communication capability corresponding to a combination of at least a first communication capability of the first device with the network and a second communication capability of the second device with the network; receiving, from the first device, the group identifier; determining the configuration information based on the group identifier; determining, based on the configuration information, that the aggregated communication capability is to be enabled for the first device and the second device; and enabling, based on a non-access stratum connection (NAS) with a device of the device group, the aggregated communication capability for at least the first device and the second device, the device being the first device or the second device.

Example 2 includes a method implemented by a first device, the method comprising: storing configuration information associated with a device group that includes the first device and a second device and for which an aggregated communication capability is to be enabled, the configuration information including a group identifier of the device group, the aggregated communication capability corresponding to a combination of at least a first communication capability of the first device with a network and a second communication capability of the second device with the network; sending, to the network, the group identifier; receiving, from the network, connection information to establish a data connection session with the network; and establishing the data connection session with the network, wherein the data connection uses the first communication capability as part of the aggregated communication capability.

Example 3 includes the method of example 1, wherein the configuration information is stored by a unified data management (UDM) network function (NF) of the network.

Example 4 includes the method of any preceding example, wherein the configuration information indicates a role of the first device in the device group.

Example 5 includes the method of example 4, wherein the configuration information indicates that the first device is a group leader and that the second device is a group member, and wherein the NAS connection is with the first device based on the first device being the group leader.

Example 6 includes the method of example 4 or 3, wherein the configuration information further includes a radio access capability signaling (RACS) identifier of the first device.

Example 7 includes the method of any preceding example, wherein a device identifier of the first device includes a subscription permanent identifier (SUPI), a globally unique temporary user equipment identifier (GUTI), or a user equipment (UE) aggregation identifier.

Example 8 includes the method of any preceding example, wherein a device identifier of the first device includes a user equipment (UE) aggregation identifier, wherein the UE aggregation identifier is based on the group identifier and a UE identifier unique within the device group.

Example 9 includes the method of any preceding example, wherein the configuration information further includes a radio access capability signaling (RACS) identifier of the first device, wherein the RACS identifier corresponds to the first communication capability that is a subset of a user equipment (UE) radio capability of the first device, and wherein the RACS identifier is provided along with a UE context by an application management function (AMF) of the network to a session management function (SMF) of the network.

Example 10 includes the method of any preceding example, wherein the configuration information is stored in a universal subscriber identity module (USIM) of the device.

Example 11 includes the method of any preceding example, wherein the device is a group leader of the device group, and wherein the data connection is established based on using a non-access stratum (NAS) connection of the device with the network, and wherein the NAS connection is used based on the device being the group leader.

Example 12 includes the method of any preceding example, wherein the device is a group leader of the device group, wherein the group identifier is sent in a registration message to the network, wherein establishing the data connection includes establishing a first protocol data unit (PDU) session with the network by at least sending an aggregation request in a PDU session establishment request or in a PDU session modification request, a first device identifier of the first device, and a second identifier of the second device to the network.

Example 13 includes the method of example 12, wherein a second PDU session is established between the second device and the network based on the aggregation request, wherein the first communication capability uses the first PDU session, and the second communication capability uses the second PDU session.

Example 14 includes the method of example 12, wherein a quality of service (QoS) flow established between the first device and an endpoint of the network and routed via the first PDU session is re-mapped to be established between the second device and the endpoint and be routed via a second PDU session.

Example 15 includes the method of any preceding example, wherein the first device is a group member of the device group, and wherein the data connection is established based on using a non-access stratum (NAS) connection of the second device with the network.

Example 16 includes the method of any preceding example, wherein the first device is a group member of the device group, wherein the group identifier is sent in a registration message or a mobility registration update (MRU) to the network, wherein establishing the data connection includes establishing a first protocol data unit (PDU) session with the network based on the registration message or the MRU message.

Example 17 includes the method example 16, wherein a quality of service (QoS) flow established between the second device and an endpoint of the network and routed via a second PDU session is re-mapped to be established between the first device and the endpoint and be routed via the first PDU session.

Example 18 includes the method example 16, wherein a quality of service (QoS) flow established between the second device and an endpoint of the network via a first radio access (RAN) of the network is re-mapped to be established between the first device and the endpoint via second RAN of the network.

Example 19 includes the method of any preceding example, wherein the aggregated communication capability includes radio access level user capabilities or non-access stratum (NAS) capabilities.

Example 20 includes a device comprising means to perform one or more elements of a method described in or related to any of the examples 2-19.

Example 21 includes one or more non-transitory computer-readable media comprising instructions to cause a device, upon execution of the instructions by one or more processors of the UE, to perform one or more elements of a method described in or related to any of the examples 2-19.

Example 22 includes a device comprising logic, modules, or circuitry to perform one or more elements of a method described in or related to any of the examples 2-19.

Example 23 includes a device comprising: one or more processors and one or more computer-readable media comprising instructions that, when executed by the one or more processors, cause the one or more processors to perform one or more elements of a method described in or related to any of the examples 2-19.

Example 24 includes a network comprising means to perform one or more elements of a method described in or related to any of the examples 1 and 3-19.

Example 25 includes one or more non-transitory computer-readable media comprising instructions to cause a network, upon execution of the instructions by one or more processors of the network, to perform one or more elements of a method described in or related to any of the examples 1 and 3-19.

Example 26 includes a network comprising logic, modules, or circuitry to perform one or more elements of a method described in or related to any of the examples 1 and 3-19.

Example 27 includes a network comprising: one or more processors and one or more computer-readable media comprising instructions that, when executed by the one or more processors, cause the one or more processors to perform one or more elements of a method described in or related to any of the examples 1 and 3-19.

Example 28 includes a system comprising means to perform one or more elements of a method described in or related to any of the examples 1-19.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

Applicant hereby claims:

1. A method implemented by a network, the method comprising:
storing configuration information associated with a device group that includes a first device and a second device and for which an aggregated communication capability is to be enabled, the configuration information including a group identifier of the device group and a device identifier for each device of the device group, the aggregated communication capability corresponding to a combination of at least a first communication capability of the first device with the network and a second communication capability of the second device with the network;
receiving, from the first device, the group identifier;
determining the configuration information based on the group identifier;
determining, based on the configuration information, that the aggregated communication capability is to be enabled for the first device and the second device; and
enabling, based on a non-access stratum connection (NAS) with a device of the device group, the aggregated communication capability for at least the first device and the second device, the device being the first device or the second device.

2. The method of claim 1, wherein the configuration information is stored by a unified data management (UDM) network function (NF) of the network.

3. The method of claim 1, wherein the configuration information indicates a role of the first device in the device group.

4. The method of claim 3, wherein the configuration information indicates that the first device is a group leader and that the second device is a group member, and wherein the NAS connection is with the first device based on the first device being the group leader.

5. The method of claim 3, wherein the configuration information further includes a radio access capability signaling (RACS) identifier of the first device.

6. The method of claim 1, wherein the device identifier of the first device includes a subscription permanent identifier (SUPI), a globally unique temporary user equipment identifier (GUTI), or a user equipment (UE) aggregation identifier.

7. The method of claim 1, wherein the device identifier of the first device includes a user equipment (UE) aggregation identifier, wherein the UE aggregation identifier is based on the group identifier and a UE identifier unique within the device group.

8. The method of claim 1, wherein the configuration information further includes a radio access capability signaling (RACS) identifier of the first device, wherein the RACS identifier corresponds to the first communication capability that is a subset of a user equipment (UE) radio capability of the first device, and wherein the RACS identifier is provided along with a UE context by an application management function (AMF) of the network to a session management function (SMF) of the network.

9. A device comprising:
one or more processors; and
one or more memory storing instructions that, upon execution by the one or more processors, configure the device to:
store configuration information associated with a device group that includes the device as a first device and a second device and for which an aggregated communication capability is to be enabled, the configuration information including a group identifier of the device group, the aggregated communication capability corresponding to a combination of at least a first communication capability of the first device with a network and a second communication capability of the second device with the network;
send, to the network, the group identifier;
receive, from the network, connection information to establish a data connection session with the network; and
establish the data connection session with the network, wherein the data connection session uses the first communication capability as part of the aggregated communication capability.

10. The device of claim 9, wherein the configuration information is stored in a universal subscriber identity module (USIM) of the device.

11. The device of claim 9, wherein the device is a group leader of the device group, and wherein the data connection session is established based on using a non-access stratum (NAS) connection of the device with the network, and wherein the NAS connection is used based on the device being the group leader.

12. The device of claim 9, wherein the device is a group leader of the device group, wherein the group identifier is sent in a registration message to the network, wherein establishing the data connection session includes establishing a first protocol data unit (PDU) session with the network by at least sending an aggregation request in a PDU session establishment request or in a PDU session modification request, a first device identifier of the first device, and a second identifier of the second device to the network.

13. The device of claim 12, wherein a second PDU session is established between the second device and the network based on the aggregation request, wherein the first communication capability uses the first PDU session, and the second communication capability uses the second PDU session.

14. The device of claim 12, wherein a quality of service (QoS) flow established between the first device and an endpoint of the network and routed via the first PDU session is re-mapped to be established between the second device and the endpoint and be routed via a second PDU session.

15. One or more computer-readable storage media storing instructions that, upon execution on a first device, cause the first device to perform operations comprising:
storing configuration information associated with a device group that includes the first device and a second device and for which an aggregated communication capability is to be enabled, the configuration information including a group identifier of the device group, the aggregated communication capability corresponding to a combination of at least a first communication capability of the first device with a network and a second communication capability of the second device with the network;
sending, to the network, the group identifier;
receiving, from the network, connection information to establish a data connection session with the network; and
establishing the data connection session with the network, wherein the data connection session uses the first communication capability as part of the aggregated communication capability.

16. The one or more computer-readable storage media of claim 15, wherein the first device is a group member of the device group, and wherein the data connection session is established based on using a non-access stratum (NAS) connection of the second device with the network.

17. The one or more computer-readable storage media of claim 15, wherein the first device is a group member of the device group, wherein the group identifier is sent in a registration message or a mobility registration update (MRU) message to the network, wherein establishing the data connection session includes establishing a first protocol data unit (PDU) session with the network based on the registration message or the MRU message.

18. The one or more computer-readable storage media of claim 17, wherein a quality of service (QoS) flow established between the second device and an endpoint of the network and routed via a second PDU session is re-mapped to be established between the first device and the endpoint and be routed via the first PDU session.

19. The one or more computer-readable storage media of claim 17, wherein a quality of service (QoS) flow established between the second device and an endpoint of the network via a first radio access (RAN) of the network is re-mapped to be established between the first device and the endpoint via second RAN of the network.

20. The one or more computer-readable storage media of claim 15, wherein the aggregated communication capability includes radio access level user capabilities or non-access stratum (NAS) capabilities.
